(19) United States
(12) Patent Application Publication
(10) Pub. No.: US 2017/0373402 A1
(43) Pub. Date: Dec. 28, 2017

(54) SERIES FED MICROSTRIP ANTENNA STRUCTURE

(71) Applicant: CUBTEK INC., Hsinchu County (TW)

(72) Inventors: SHYH-JONG CHUNG, Hsinchu County (TW); HSIAO-NING WANG, Hsinchu County (TW)

(21) Appl. No.: 15/634,603

(22) Filed: Jun. 27, 2017

(30) Foreign Application Priority Data
Jun. 28, 2016 (TW) 105209683

(51) Int. Cl. H01Q 21/00; H01Q 9/40; H01Q 9/04

(52) U.S. Cl. CPC H01Q 21/0075; H01Q 9/045; H01Q 9/40

(57) ABSTRACT

A series fed microstrip antenna structure includes a substrate, a patterned conductive layer disposed on the upper surface of the substrate, and a grounding layer disposed on the lower surface of the substrate. The patterned conductive layer includes a conductive wire and a plurality of radiator units, wherein each radiator unit is connected with the conductive wire by a feed line. A matched radiator unit disposed on the substrate and electrically connected with the conductive wire. With such configuration, the structure is simple and facilitates the massive production. Also, the antenna bandwidth is increased, and the antenna gain is improved.

### BACKGROUND OF THE INVENTION

1. Field of the Invention

The present invention relates to antenna structures, and more particularly, to a series fed microstrip antenna structure having matched radiators.

2. Description of the Related Art

Conventionally, a microstrip antenna is a flat structure, which is able to be massively produced and advantageously integrated on active components or circuit boards. Therefore, the microstrip antenna structure is commonly applied on various portable electronic devices, such as smart phones, tablets, global positioning system (GPS), and RFID. For further improving the gain of the microstrip antenna in order to improve the transmission distance of the wireless signal, the radiators thereof are usually disposed in an array arrangement to form an array antenna.

A conventional structure of an array antenna comprises a mediate substrate, a grounding plate, a plurality of radiators, and at least a feed network, wherein the at least one radiator is disposed above the mediate substrate, the grounding plate is disposed below the mediate substrate, and the grounding plate is connected with the grounding of a RF circuit of a wireless communication device. Regarding a conventional series fed microstrip antenna, due to a larger Q value of the array, issues of narrower bandwidth and lower radiation efficiency exist. Further, the single conductive plate in the series fed microstrip antenna imposes great effect upon the performance. The conductive plates produced in batches lack equality and uniformity, thereby affecting the composition of a huge antenna array of the microstrip antennas. Therefore, it is desirable to provide a simple structure which facilitates the batch production and improves the bandwidth of the antennas.

### SUMMARY OF THE INVENTION

For improving the issues above, a series fed microstrip antenna structure is disclosed. By used of matched radiators, a simple structure facilitating a batch production is achieved, and the bandwidth of antenna is improved, so as to increase the antenna gain.

For achieving the aforementioned objectives, a series fed microstrip antenna structure is provided, comprising:

a substrate provided with an upper surface and a lower surface;

a patterned conductive layer disposed on the upper surface of the substrate and including;
a conductive wire; and
a plurality of radiator units disposed on two sides of the conductive wire, each radiator unit including a conductive plate and a feed line, the feed line connecting the conductive plate and the conductive wire;

a matched radiator unit disposed on the substrate and electrically connected with the conductive wire; and

a grounding layer disposed on the lower surface of the substrate.

Preferably, the plurality of radiator units are disposed on two sides of the conductive wire in a string shape arrangement.

Preferably, the conductive plates are different sized.

Preferably, the conductive wire is arranged in a straight line orientation, and the matched radiator unit is disposed at the distal end of the conductive wire.

Preferably, the conductive plates are arranged in order of size toward the matched radiator unit, wherein the conductive plate with the largest size is most close to the matched radiator unit.

Preferably, the width of the conductive wire is larger than the width of each feed line.

Preferably, each conductive plate is disposed to form an angle with the conductive wire.

Preferably, the matched radiator unit is disposed at the distal end of the conductive wire and connected with the conductive wire, wherein the matched radiator unit is inclined from the conductive wire in an angle which is identical to the angle formed by the conductive plate with the conductive wire.

Preferably, the angle is 45 or 90 degrees.

### BRIEF DESCRIPTION OF THE DRAWINGS

FIG. 1 is a top view or the series fed microstrip antenna structure in accordance with an embodiment of the present invention.

FIG. 2 is a cross-sectional view taken along line A-A in FIG. 1.

FIG. 3 is a top view of the series fed microstrip antenna structure in accordance with another embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion. Embodiments of the present invention are illustrated in detail along with the drawings. However, the technical features included by the present invention are not limited to certain embodiments hereby provided. Scope of the present invention shall be referred to the claims, which include all the possible replacements, modifications, and equivalent features. Identical or similar components are marked with same numeric in the drawings. For the briefness of drawings, irrelevant details and known components are omitted, so as to prevent unnecessary limitations. Therefore, embodiments of the present invention are still allowed to be realized without the unnecessary details.

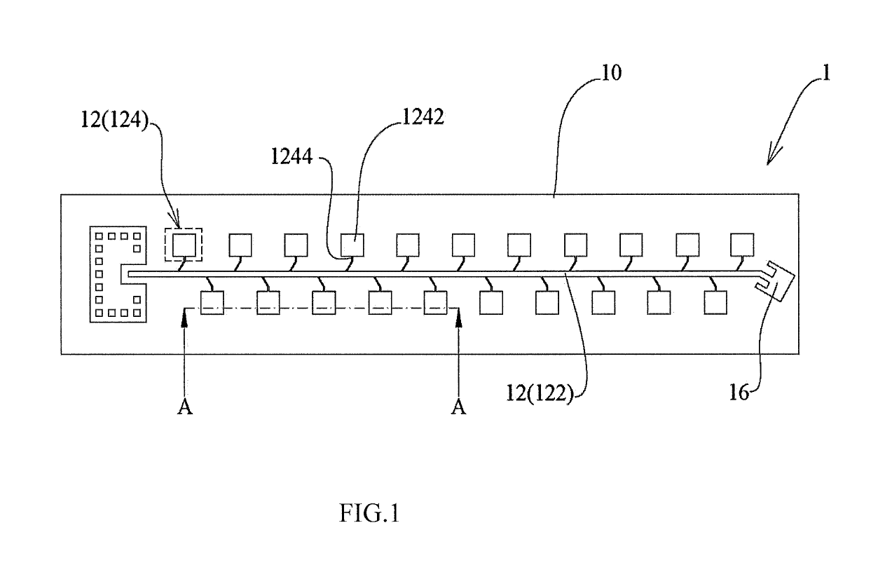

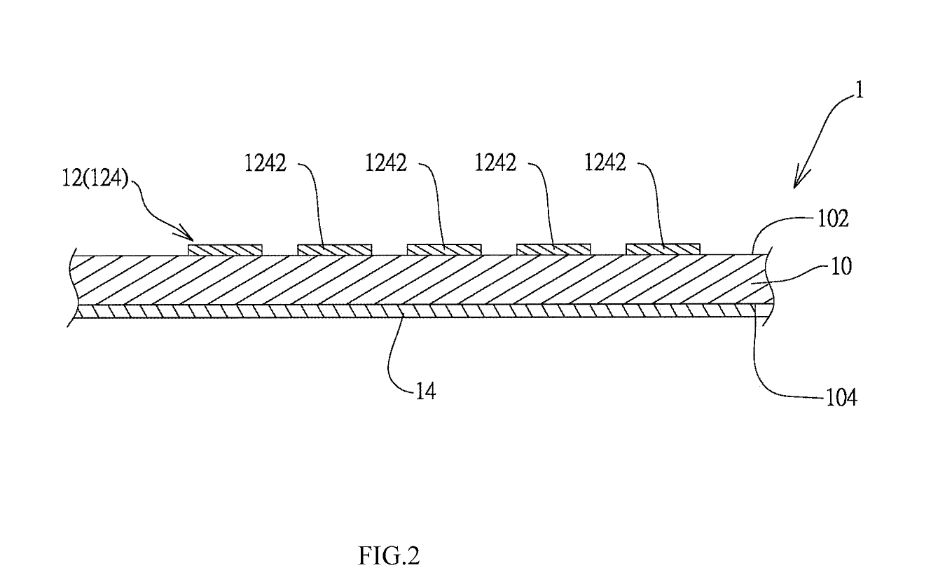

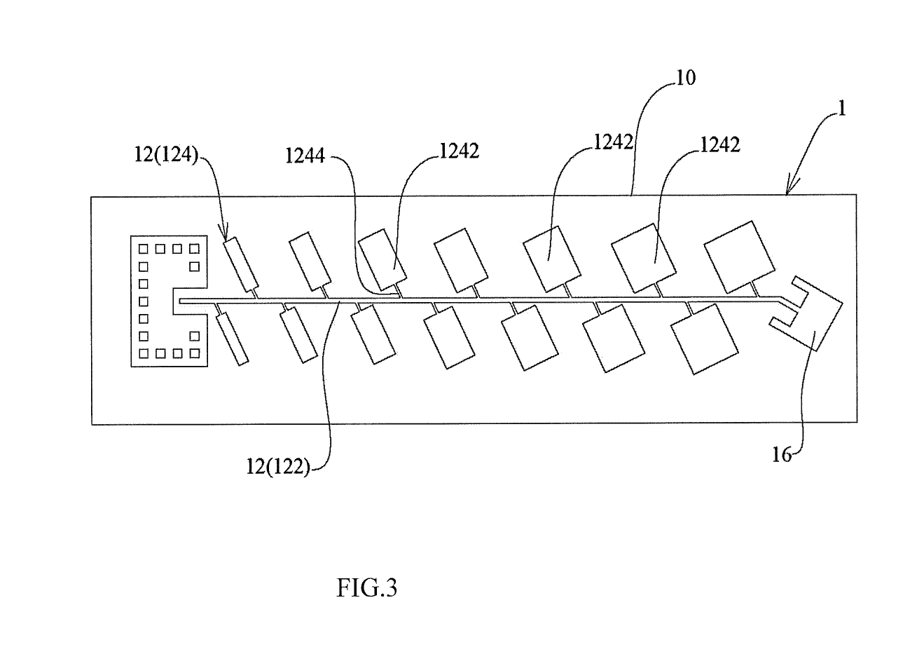

Referring to FIG. 1 and FIG. 2, the series fed microstrip antenna structure 1 comprises a substrate 10, a patterned conductive layer 12 disposed on an upper surface 102 of the substrate 10, and a grounding layer 14 disposed on a lower surface 104 of the substrate 10. The patterned conductive layer 12 comprises a conductive wire 122 extending in a straight line orientation and a plurality of radiator units 124, wherein each radiator unit 124 is disposed on two sides of the conductive wire 122. Also, each radiator unit 124 comprises a conductive plate 1242 and a feed line 1244, wherein the feed line 1244 is electrically connected to the conductive plate 1242 and the conductive wire 122. The width of the conductive wire 122 is larger than the width of the feed line 1244, and each conductive plate 1242 is disposed to form an angle with the conductive wire 122, as shown by FIG. 1, wherein the angle is 90 degrees, or as shown by FIG. 3, wherein the angle is 45 degrees. Therefore, the conductive plate 1242 is arranged more closed to the conductive wire 122. However, the degrees of the angle is only for illustration of the embodiments and not used to limit the features of the present invention.

A matched radiator unit 16 is disposed on the substrate 10 and electrically connected with the conductive wire 122. In an embodiment of the present invention, the radiators units 124 are disposed on two sides of the conductive wire 122 and arranged in a string shape array. The antenna structure of the present invention is structurally simple and facilitates the massive production. Also, the matched radiator unit 16 not only increases the antenna bandwidth, but also is able to act as a radiator unit for improving the gain of the antenna.

Accordingly, referring to FIG. 3, in an embodiment of the present invention, the conductive plate 1242 in each radiator unit 124 is different sized. Also, the matched radiator unit 16 is disposed at the distal end of the conductive wire 122, and is inclined from the conductive wire 122. Furthermore, the matched radiator unit 16 is inclined from the conductive wire 122 in an angle which is identical to the angle formed by the conductive plate 1242 with the conductive wire 122. In another embodiment, the plurality of radiator units 124 are disposed in order of size from where the signal feeds in toward the matched radiator unit 16, wherein the largest radiator unit 124 is most close to the matched radiator unit 16.

To sum up, the series fed microstrip antenna structure, by use of a matched radiator unit 16 structure, is structurally simple and facilitates the massive production. Also, the antenna bandwidth is increased. Furthermore, the matched radiator unit 16 is able to act as a radiator unit 124 for efficiently improving the antenna gain.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A series fed microstrip antenna structure, comprising:
a substrate provided with an upper surface and a lower surface;
a patterned conductive layer disposed on the upper surface of the substrate and including;
a conductive wire; and
a plurality of radiator units disposed on two sides of the conductive wire, each radiator unit including a conductive plate and a feed line, the feed line connecting the conductive plate and the conductive wire;
a matched radiator unit disposed on the substrate and electrically connected with the conductive wire; and
a grounding layer disposed on the lower surface of the substrate.

2. The microstrip antenna structure of claim 1, wherein the plurality of radiator units are disposed on two sides of the conductive wire in a string shape arrangement.

3. The microstrip antenna structure of claim 1, wherein the conductive plates are different sized.

4. The microstrip antenna structure of claim 1, wherein the conductive wire is arranged in a straight line orientation, and the matched radiator unit is disposed at a distal end of the conductive wire.

5. The microstrip antenna structure of claim 3, wherein the conductive plates are arranged in order of size toward the matched radiator unit, wherein the conductive plate with the largest size is most close to the matched radiator unit.

6. The microstrip antenna structure of claim 1, wherein a width of the conductive wire is larger than a width of each feed line.

7. The microstrip antenna structure of claim 1, wherein each conductive plate is disposed to form an angle with the conductive wire.

8. The microstrip antenna structure of claim 7, wherein the matched radiator unit is disposed at a distal end of the conductive wire and connected with the conductive wire, and the matched radiator unit is inclined from the conductive wire in an angle which is identical to the angle formed by the conductive plate with the conductive wire.

9. The microstrip antenna structure of claim 8, wherein both the angles are 45 degrees.

10. The microstrip antenna structure of claim 8, wherein both the angles are 90 degrees.
